(19) United States
(12) Patent Application Publication
(10) Pub. No.: US 2004/0220890 A1
(43) Pub. Date: Nov. 4, 2004

(54) Item handling system and method

(75) Inventor: Keith McMurray Boden, Reigate (GB)

Correspondence Address: SHOEMAKER AND MATTARE, LTD, 10 POST OFFICE ROAD - SUITE 110, SILVER SPRING, MD, 20910, US

(73) Assignee: Neopost Industrie SA, Bagneux (FR)

(21) Appl. No.: 10/768,195

(22) Filed: Feb. 2, 2004

(30) Foreign Application Priority Data
Jan. 31, 2003 (GB) 0302274.6

(51) Int. Cl. G06F 17/60; G06F 17/00

(52) U.S. Cl. 705/404; 705/401; 705/1

(57) ABSTRACT

An item handling system and method, the item handling system comprising: at least one item printing unit for printing destination address codes on items, each destination address code corresponding to a destination address to which the respective item is to be delivered; and a plurality of item processing units through at least one of which the items are processed in delivery to the respective destination addresses, each item processing unit including an item handler for reading the destination address code on each item, determining, for each item, through use of the destination address code, a destination item processing unit which is local to the destination address, and routing each item to the destination item processing unit.

### FIELD OF THE INVENTION

The present invention relates to an item handling system for and a method of handling items, typically mail items, to be delivered to destination addresses.

### BACKGROUND OF THE INVENTION

Currently, mail handling systems Which provide for the delivery of mail items to destination addresses apply a postage indicium, including a cryptographically-encoded element, typically a two-dimensional barcode, to each mail item, which confirms the payment of the handling charge for delivering the mail item.

In such mail handling systems, the cryptographically-encoded element of the postage indicium acts as the means of security against fraud, since, to print a valid postage indicium, the relevant cryptographic key or keys would be required. However, should the relevant cryptographic key or keys become compromised, the mail handling system is open to fraud. Also, it is possible that a valid postage indicium can be copied and applied to a plurality of mail items each having a different destination address.

It is an aim of the present invention to provide an item handling system and method which does not rely on the provision of a human-readable destination address for handling an item, such as by way of a post or zip code, but rather requires the handling of an item by reference only to an applied destination address code. In this way, irrespective of any human-readable destination address on an item, the item will be directed to the local item processing center as defined by the destination address associated with the destination address code.

### SUMMARY OF THE INVENTION

In one aspect the present invention provides an item handling system, comprising: at least one item printing unit for printing destination address codes on items, each destination address code corresponding to a destination address to which the respective item is to be delivered; and a plurality of item processing units through at least one of which the items are processed in delivery to the respective destination addresses, each item processing unit including an item handler for reading the destination address code on each item, determining, for each item, through use of the destination address code, a destination item processing unit which is local to the destination address, and routing each item to the destination item processing unit.

In one embodiment the system further comprises: a data station which is in communication with the at least one item printing unit, either directly or indirectly, such as to receive address information corresponding to each destination address code, which address information is available to the item processing units in processing the items.

Preferably, the system comprises: a plurality of item printing units for printing destination address codes on items.

Preferably, the item handler of each item processing unit is configured to route items only through use of the destination address codes.

In one embodiment at least ones of the items each bear a human-readable destination address, so as to allow for delivery to the respective destination addresses following routing of the items to the respective destination item processing units.

In another embodiment at least ones of the items each bear no human-readable destination address.

Preferably, each item processing unit includes an address printer for printing delivery addresses on items bearing no human-readable destination addresses.

More preferably, the delivery address comprises sufficient information only to allow the respective item to be delivered following routing of the item to the destination item processing unit.

Preferably, the destination address codes comprise alphanumeric strings.

More preferably, the destination address codes comprise numeric strings.

In one embodiment the destination address codes are cryptographically encoded.

Preferably, the destination address codes contain no embedded destination address information.

More preferably, the destination address codes contain no embedded information and act only as pointers to destination address information.

In one embodiment each destination address code is effective only for a predeterminable active period, such that, after expiration of the active period, the destination address code is inoperative and does not allowing for routing by the item processing units.

Preferably, the items comprise mail items, such as letters and parcels.

In another aspect the present invention provides a method of handling items, comprising the steps of: printing destination address codes on items, each destination address code corresponding to a destination address to which the respective item is to be delivered; and processing items through at least one of a plurality of item processing units in delivery of the items to the respective destination addresses, wherein the item processing step comprises the steps of: reading the destination address code on each item; determining, for each item, through use of the destination address code, a destination item processing unit which is local to the destination address; and routing each item to the destination item processing unit.

In one embodiment the method further comprises the step of: communicating, either directly or indirectly, address information corresponding to each destination address code from the at least one item printing unit to a data station, which address information is available to the item processing units in processing the items.

Preferably, the items are processed only through use of the destination address codes.

In one embodiment at least ones of the items each bear a human-readable destination address, so as to allow for delivery to the respective destination addresses following routing of the items to the respective destination item processing units.

In another embodiment at least ones of the items each bear no human-readable destination address.

Preferably, the item processing step further comprises the step of: printing delivery addresses on mail items bearing no human-readable destination addresses.

More preferably, the delivery address comprises sufficient information only to allow the respective item to be delivered following routing of the item to the destination item processing unit.

Preferably, the destination address codes comprise alphanumeric strings.

More preferably, the destination address codes comprise numeric strings.

In one embodiment the destination address codes are cryptographically encoded.

Preferably, the destination address codes contain no embedded destination address information.

More preferably, the destination address codes contain no embedded information and act only as pointers to destination address information.

In one embodiment each destination address code is effective only for a predeterminable active period, such that, after expiration of the active period, the destination address code is inoperative and does not allowing for processing by the mail processing units.

Preferably, the items comprise mail items, such as letters and parcels.

### BRIEF DESCRIPTION OF THE DRAWING

A preferred embodiment of the present invention will now be described hereinbelow by way of example only with reference to the accompanying drawings, in which:

FIG. 1 illustrates a mail handling system in accordance with a preferred embodiment of the present invention.

### DETAILED DESCRIPTION OF THE PREFERRED EMBODIMENT

The mail handling system comprises at least one mail printing unit 1, in this embodiment a plurality of mail printing units 1a, 1b for printing destination address codes 3 on mail items 5. In one embodiment the destination address codes 3 are cryptographically-encoded codes. In another embodiment the destination address codes 3 are unencoded, plain text codes. In a preferred embodiment the destination address codes 3 do not contain any embedded destination address information, and in one embodiment contain no embedded information and merely represent pointers to available destination address information. In containing little or no embedded information, the destination address codes 3 can be codes which are readily machine readable, both in terms of optical inspection and processing, as compared to two-dimensional data matrices which are problematic to optically inspect and process.

The mail handling system further comprises a remote addressing station 7 which is in operative communication with the mail printing units 1a, 1b such as to obtain the address information for each destination address code 3 as applied to the mail items 5. In this embodiment the mail printing units 1a, 1b are in direct communication with the remote addressing station 7, such as to provide for the address information to be downloaded directly to the addressing station 7 from the mail printing units 1a, 1b. In another embodiment the mail printing units 1a, 1b can be in communication with a control center which is in turn in operative communication with the addressing station 7, such that the address information can be downloaded in a single transaction from the control center, instead of individually from each of the mail printing units 1a, 1b. In one embodiment the address information is downloaded at intervals, typically daily at the time of introducing the mail items 5 into the mail stream.

In this embodiment the addressing station 7 stores the address information for each destination address code 3, and, for each destination address, determines that mail processing unit 9a, 9b, 9c which is local to the destination address, with the function of the mail processing units 9a, 9b, 9c being described in more detail hereinbelow. By determining that mail processing unit 9a, 9b, 9c which is local to a destination address and assigning a local processing unit designator, processing of the destination address by the mail processing units 9a, 9b, 9c can be avoided.

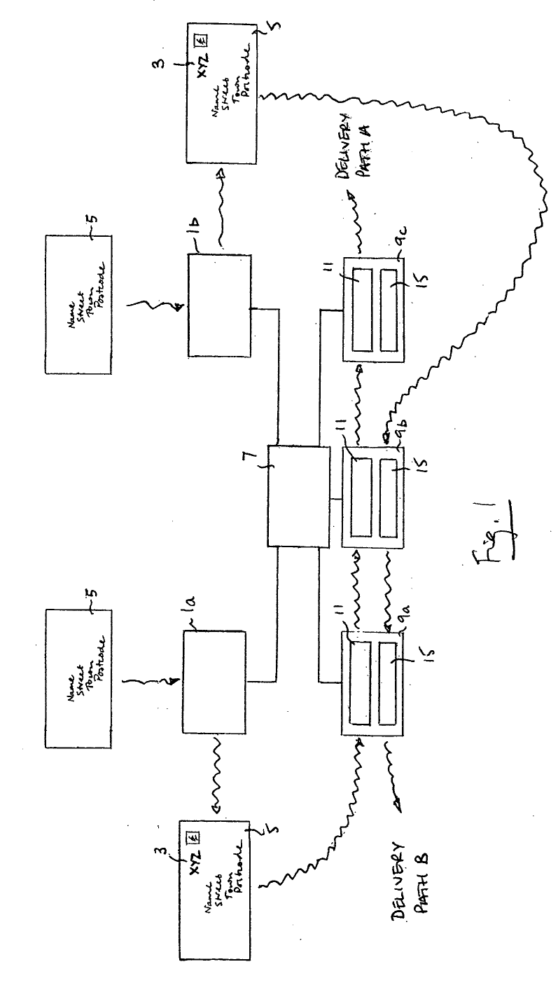

The mail handling system further comprises a plurality of, in this embodiment three mail processing units 9a, 9b, 9c which receive mail items 5 and process the same in routing the mail items 5 to respective destination addresses. In FIG. 1, the processing of a mail item 5 from each of the mail printing units 1a, 1b is represented by two exemplary mail delivery paths, these being Delivery Path A and Delivery Path B. For the mail item 5 as printed by the first mail printing unit 1a and following Delivery Path A, the first mail processing unit 9a is a unit local to the sender, the third mail processing unit 9c is a unit local to the destination address of the mail item 5, and the second mail processing unit 9b is a unit intermediate the first and third mail processing units 9a, 9c through which the mail item 5 is routed by the first mail processing unit 9a. For the mail item 5 as printed by the second mail printing unit 1b and following Delivery Path B, the second mail processing unit 9b is a unit local to the sender, and the first mail processing unit 9a is a unit local to the destination address of the mail item 5.

In this embodiment the mail processing units 9a, 9b, 9c are in communication with the addressing station 7, such that the address information corresponding to active destination address codes 3 is downloaded so as to be available locally. In an alternative embodiment the mail processing units 9a, 9b, 9c could be in communication with the addressing station 7 such as to allow the address information corresponding to active destination address codes 3 to be queried as required.

In one embodiment the destination address codes 3 can be rendered active only for a predetermined period, such that, after expiration of this period, typically a limited number of days, the destination address codes 3 are inoperative and do not allow for processing by the mail processing units 9a, 9b, 9c.

The mail processing units 9a, 9b, 9c each include a mail handler 11 for reading the destination address code 3 from each mail item 5, retrieving the local processing unit designator, and routing the mail item 5, either for delivery to the destination address from the respective mail processing unit 9a, 9b, 9c or onward to the local mail processing unit 9a, 9b, 9c for delivery to the destination address.

The mail processing units 9a, 9b, 9c each further include an address printer 15 which is operable to print a delivery address on mail items 5 bearing no human-readable destination address. In this embodiment the destination address codes 3 each have an associated address flag which flags whether or not the respective mail item 5 includes a human-readable destination address. Where the address flag of any mail item 5 indicates that the mail item 5 bears no human-readable destination address, the human-readable destination address is retrieved using the destination address code 3, and applied by the address printer 15 of the local mail processing unit 9a, 9b, 9c, typically as an address line, for example, 1 Massetts Road, to enable delivery.

In one embodiment each mail item 5 bears a destination address, and, on arrival of mail items 5 at the local mail processing unit 9a, 9b, 9c, the destination address is utilized to effect delivery. In this way, any attempt at applying a fraudulent destination address code 3 to a mail item 5 is ineffective, as the mail item 5 is routed to the local mail processing unit 9a, 9b, 9c as defined by the destination address code 3 and not any human-readable destination address. Thus, if, for example, a destination address code 3 is copied from another mail item 5, the mail item 5 having that fraudulent destination address code 3 will be delivered to the local mail processing unit 9a, 9b, 9c as defined by that destination address code 3, and the mail delivery person will immediately recognize that the mail item 5 does not have a local destination address, in which case the mail item 5 will not be delivered and the sender can be contacted.

In another embodiment each mail item 5 bears no human-readable destination address, and the human-readable destination address for each mail item 5 is retrieved using the respective destination address code 3, and applied by the address printer 15 of the local mail processing unit 9a, 9b, 9c, typically as an address line, for example, 1 Massetts Road, to enable delivery. In this embodiment the destination address is printed as an address line which would only allow for delivery from the local mail processing unit 9a, 9b, 9c, and not any others of the mail processing units 9a, 9b, 9c.

In a further embodiment ones of the mail items 5 bear a human-readable destination address and ones of the mail items bear no human-readable destination address, with those mail items 5 which bear a human-readable destination address being delivered by utilizing the human-readable destination address on arrival of the mail items 5 at the local mail processing unit 9a, 9b, 9c, and those mail items 5 which bear no human-readable destination address having human-readable destination addresses applied thereto by the address printers 15 of the local mail processing units 9a, 9b, 9c, typically as address lines, to enable delivery.

With this configuration, the need for a complex, cryptographically-encoded postage indicia is obviated. Instead, a much simpler destination address code 3 is applied to each mail item 5. In one embodiment the destination address code 3 can be an alphanumeric string, and even a numeric string. This simpler destination address code 3 facilitates processing at the mail printing units 1a, 1b, and, in not requiring a complex two-dimensional representation which embeds postage information, facilitates reading at the mail processing units 9a, 9b, 9c.

Finally, it will be understood that the present invention has been described in its preferred embodiments and can be modified in many different ways without departing from the scope of the invention as defined by the appended claims.

1. An item handling system, comprising:
at least one item printing unit for printing destination address codes on items, each destination address code corresponding to a destination address to which the respective item is to be delivered; and
a plurality of item processing units through at least one of which the items are processed in delivery to the respective destination addresses, each item processing unit including an item handler for reading the destination address code on each item, determining, for each item, through use of the destination address code, a destination item processing unit which is local to the destination address, and routing each item to the destination item processing unit.

2. The system of claim 1, further comprising:
a data station which is in communication with the at least one item printing unit, either directly or indirectly, such as to receive address information corresponding to each destination address code, which address information is available to the item processing units in processing the items.

3. The system of claim 1, comprising:
a plurality of item printing units for printing destination address codes on items.

4. The system of claim 1, wherein the item handler of each item processing unit is configured to route items only through use of the destination address codes.

5. The system of claim 1, wherein at least ones of the items each bear a human-readable destination address, so as to allow for delivery to the respective destination addresses following routing of the items to the respective destination item processing units.

6. The system of claim 1, wherein at least ones of the items each bear no human-readable destination address.

7. The system of claim 6, wherein each item processing unit includes an address printer for printing delivery addresses on items bearing no human-readable destination addresses.

8. The system of claim 7, wherein the delivery address comprises sufficient information only to allow the respective item to be delivered following routing of the item to the destination item processing unit.

9. The system of claim 1, wherein the destination address codes comprise alphanumeric strings.

10. The system of claim 9, wherein the destination address codes comprise numeric strings.

11. The system of claim 1, wherein the destination address codes are cryptographically encoded.

12. The system of claim 1, wherein the destination address codes contain no embedded destination address information.

13. The system of claim 12, wherein the destination address codes contain no embedded information and act only as pointers to destination address information.

14. The system of claim 1, wherein each destination address code is effective only for a predeterminable active period, such that, after expiration of the active period, the destination address code is inoperative and does not allowing for processing by the item processing units.

15. The system of claim 1, wherein the items comprise mail items, such as letters and parcels.

16. A method of handling items, comprising the steps of:
printing destination address codes on items, each destination address code corresponding to a destination address to which the respective item is to be delivered; and
processing items through at least one of a plurality of item processing units in delivery of the items to the respective destination addresses, wherein the item processing step comprises the steps of:
reading the destination address code on each item;
determining, for each item, through use of the destination address code, a destination item processing unit which is local to the destination address; and
routing each item to the destination item processing unit.

17. The method of claim 16, further comprising the step of:
communicating, either directly or indirectly, address information corresponding to each destination address code from the at least one item printing unit to a data station, which address information is available to the item processing units in processing the items.

18. The method of claim 16, wherein the items are processed only through use of the destination address codes.

19. The method of claim 16, wherein at least ones of the items each bear a human-readable destination address, so as to allow for delivery to the respective destination addresses following routing of the items to the respective destination item processing units.

20. The method of claim 16, wherein at least ones of the items each bear no human-readable destination address.

21. The method of claim 20, wherein the item processing step further comprises the step of:
printing delivery addresses on items bearing no human-readable destination addresses.

22. The method of claim 21, wherein the delivery address comprises sufficient information only to allow the respective item to be delivered following routing of the item to the destination item processing unit.

23. The method of claim 16, wherein the destination address codes comprise alphanumeric strings.

24. The method of claim 23, wherein the destination address codes comprise numeric strings.

25. The method of claim 16, wherein the destination address codes are cryptographically encoded.

26. The method of claim 16, wherein the destination address codes contain no embedded destination address information.

27. The method of claim 26, wherein the destination address codes contain no embedded information and act only as pointers to destination address information.

28. The method of claim 16, wherein each destination address code is effective only for a predeterminable active period, such that, after expiration of the active period, the destination address code is inoperative and does not allowing for processing by the item processing units.

29. The method of claim 16, wherein the items comprise mail items, such as letters and parcels.
